(19) United States
(12) Patent Application Publication
(10) Pub. No.: US 2019/0268207 A1
(43) Pub. Date: Aug. 29, 2019

(54) Compact Downlink Control Information Design And Operations In Mobile Communications

(71) Applicant: MediaTek Singapore Pte. Ltd., Singapore (SG)

(72) Inventors: Mohammed S Aleabe Al-Imari, Cambridge (GB); Raghavendra Ramakrishna, Cambridge (GB)

(21) Appl. No.: 16/285,097

(22) Filed: Feb. 25, 2019

Related U.S. Application Data
(60) Provisional application No. 62/634,980, filed on Feb. 26, 2018.
(60) Provisional application No. 62/651,788, filed on Apr. 3, 2018.

(51) Int. Cl. H04L 27/26; H04L 1/18; H04L 5/00; H04W 72/04

(52) U.S. Cl. CPC H04L 27/2666; H04L 1/1812; H04W 72/042; H04L 5/001; H04L 5/0053

(57) ABSTRACT

Various solutions for compact downlink control information (DCI) design and operations with respect to user equipment and network apparatus in mobile communications are described. An apparatus may determine that the compact DCI is supported on a first subcarrier spacing (SCS). The apparatus may monitor the compact DCI on the first SCS. The apparatus may use the compact DCI in a control channel in performing a high-reliability service.

### CROSS REFERENCE TO RELATED PATENT APPLICATION(S)

The present disclosure claims the priority benefit of U.S. Provisional Patent Application No. 62/634,980, filed 26 Feb. 2018, and U.S. Provisional Patent Application No. 62/651,788, filed 3 Apr. 2018. The contents of aforementioned applications are herein incorporated by reference in their entirety.

### TECHNICAL FIELD

The present disclosure is generally related to mobile communications and, more particularly, to compact downlink control information (DCI) design and operations with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), ultra-reliable and low latency communications (URLLC) is supported for emerging applications that demands high requirements on end-to-end latency and reliability. A general URLLC reliability requirement is that a packet of size 32 bytes shall be transmitted within 1 millisecond end-to-end latency with a success probability of 10⁻⁵. URLLC traffic is typically sporadic and short whereas low-latency and high-reliability requirements are stringent. For example, the control reliability of URLLC has to be stricter than the data reliability which is up to 10⁻⁶ BLER.

Some of the fields of the normal DCI are not applicable or does not make sense for the high latency sensitive transmissions. Reliability of the DCI depends on the size. The smaller the size of DCI is, the better the reliability may be given that the transmission resources are same due to the lower coding gain. Using normal DCI for the same reliability may need to increase the aggregation level, which has the drawback of blocking probability. Besides, smaller bandwidth parts may not be able to accommodate higher aggregation levels. Therefore, compact DCI design is needed by the fact that the normal DCI size is large and inefficient for the URLLC control transmissions.

It can be expected to have a diverse range of URLLC services in the future, each targeting a different use case. Accordingly, how to fulfil strict reliability requirements may become a new issue in the newly developed communication system. It is needed to provide proper compact DCI design and operations to reduce DCI size and improve reliability for control signal transmissions.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to compact DCI design and operations with respect to user equipment and network apparatus in mobile communications.

In one aspect, a method may involve an apparatus determining that compact DCI is supported on a first SCS. The method may also involve the apparatus monitoring the compact DCI on the first SCS. The method may further involve the apparatus performing a high-reliability service using the compact DCI in a control channel.

In one aspect, an apparatus may comprise a transceiver capable of wirelessly communicating with a network node of a wireless network. The apparatus may also comprise a processor communicatively coupled to the transceiver. The processor may be capable of determining that compact DCI is supported on a first SCS. The processor may also be capable of monitoring the compact DCI on the first SCS. The processor may further be capable of performing a high-reliability service using the compact DCI in a control channel.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (loT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting example scenarios under schemes in accordance with implementations of the present disclosure.

FIG. 3 is a diagram depicting example scenarios under schemes in accordance with implementations of the present disclosure.

FIG. 4 is a diagram depicting example scenarios under schemes in accordance with implementations of the present disclosure.

FIG. 5 is a diagram depicting an example scenario under schemes in accordance with implementations of the present disclosure.

FIG. 6 is a diagram depicting example scenarios under schemes in accordance with implementations of the present disclosure.

FIG. 7 is a diagram depicting example scenarios under schemes in accordance with implementations of the present disclosure.

FIG. 8 is a diagram depicting example scenarios under schemes in accordance with implementations of the present disclosure.

FIG. 9 is a block diagram of an example communication apparatus and an example network apparatus in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to compact DCI design and operations with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, URLLC is supported for emerging applications that demands high requirements on end-to-end latency and reliability. A general URLLC reliability requirement is that a packet of size 32 bytes shall be transmitted within 1 millisecond end-to-end latency with a success probability of 10⁻⁵. URLLC traffic is typically sporadic and short whereas low-latency and high-reliability requirements are stringent. For example, the control reliability of URLLC has to be stricter than the data reliability which is up to 10⁻⁶ BLER.

Some of the fields of the normal DCI are not applicable or does not make sense for the high latency sensitive transmissions. Reliability of the DCI depends on the size. The smaller the size of DCI is, the better the reliability may be given that the transmission resources are same due to the lower coding gain. Using normal DCI for the same reliability may need to increase the aggregation level, which has the drawback of blocking probability. Besides, smaller bandwidth parts may not be able to accommodate higher aggregation levels. Accordingly, compact DCI design is needed by the fact that the normal DCI size is large and inefficient for the URLLC control transmissions.

In view of the above, the present disclosure proposes a number of schemes pertaining to compact DCI design and operations with respect to the user equipment (UE) and the network apparatus. According to the schemes of the present disclosure, compact DCI format for URLLC may be defined and used for URLLC services. The bit-fields of compact DCI may be carefully designed to reduce the size of the DCI. Compact DCI design for URLLC may improve the reliability of control channel. Such design may also reduce the need for higher aggregation level to meet the reliability thereby reducing the blocking probability.

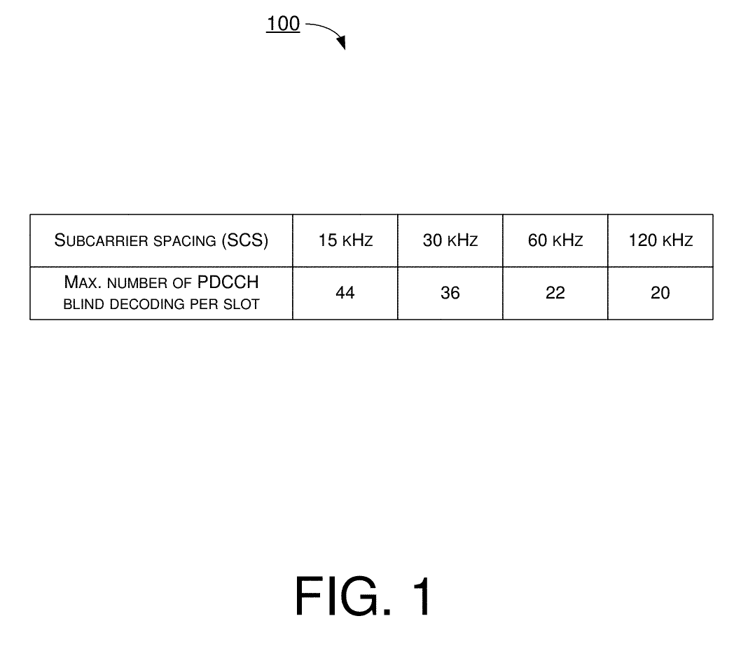

The compact DCI may add the DCI formats needed to be monitored by the UE. This may increase the number of blind decoding at the UE. To control the UE complexity, generally there is a limit on the number of blind decoding that the UE should perform within a specified period of time (e.g. search space or slot duration, etc.). The limit on the number of blind decoding may depend on the operating setting such as the subcarrier spacing (SCS). FIG. 1 illustrates an example scenario 100 under schemes in accordance with implementations of the present disclosure. Scenario 100 involves a UE and a network apparatus, which may be a part of a wireless communication network (e.g., an LTE network, an LTE-Advanced network, an LTE-Advanced Pro network, a 5G network, an NR network, an loT network or an NB-IoT network). FIG. 1 shows an example table for the limit on the maximum number of physical downlink control channel (PDCCH) blind decoding per slot with respect to different SCSs. As shown, higher SCS may have lower limit on the number of blind decoding. Therefore, monitoring several DCI with different sizes may not be feasible at large SCS. On the other hand, the possible number of transmissions/retransmissions may depend on the SCS. With 15 kHz SCS, the network apparatus may not have opportunity for re-transmissions within the latency restriction since larger symbol durations may add to latency. Thus, having reliable PDCCH (e.g. via compact DCI design) is important. With 30 kHz, 60 kHz or 120 kHz SCS, there are more opportunities for retransmissions within the latency restriction. Thus, the reliability of the PDCCH can be relaxed compared to smaller SCS.

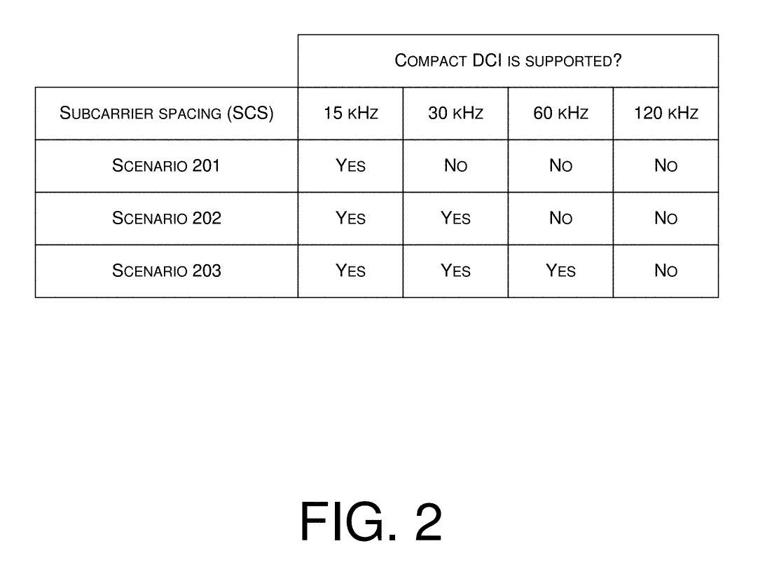

FIG. 2 illustrates example scenarios 201, 202 and 203 under schemes in accordance with implementations of the present disclosure. Scenarios 201, 202 and 203 involve a UE and a network apparatus, which may be a part of a wireless communication network (e.g., an LTE network, an LTE-Advanced network, an LTE-Advanced Pro network, a 5G network, an NR network, an loT network or an NB-IoT network). In view of the difference between the possible SCS in terms of the limit on the number of blind decoding and the possible number of retransmissions within the latency restriction, compact DCI design and/or operations should be SCS depended. Specifically, the compact DCI may be supported only for some specific SCSs. For example, in scenario 201, the compact DCI may be supported only for 15 kHz SCS, and it may not be supported in other SCSs (e.g., 30 kHz, 60 kHz and 120 kHz). In scenario 202, the compact DCI may be supported only for 15 kHz and 30 kHz SCSs, and it may not be supported for other SCSs (e.g., 60 kHz and 120 kHz). In scenario 203, the compact DCI may be supported only for 15 kHz, 30 kHz and 60 kHz SCSs, and it may not be supported for other SCSs (e.g., 120 kHz or higher SCS).

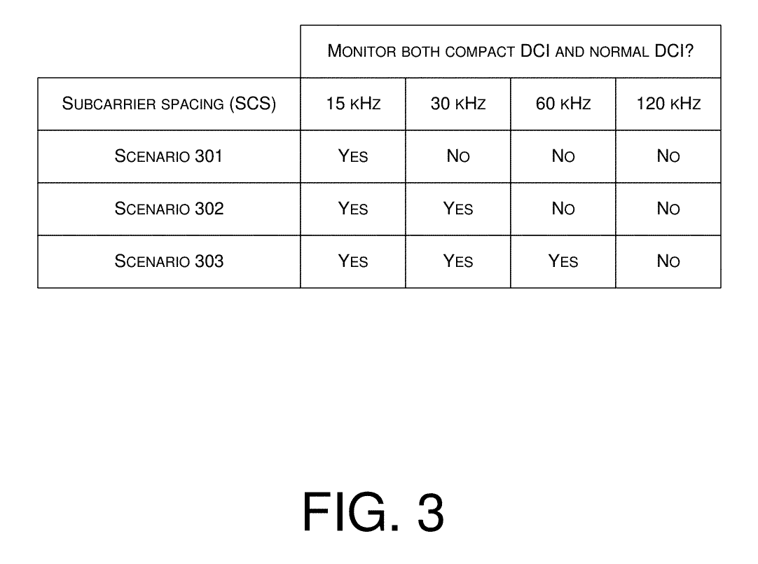

FIG. 3 illustrates example scenarios 301, 302 and 303 under schemes in accordance with implementations of the present disclosure. Scenarios 301, 302 and 303 involve a UE and a network apparatus, which may be a part of a wireless communication network (e.g., an LTE network, an LTE-Advanced network, an LTE-Advanced Pro network, a 5G network, an NR network, an loT network or an NB-IoT network). The monitoring of the compact DCI may be restricted on specific SCSs. When the UE is configured to monitor the compact DCI, some limits may be configured on the other DCI formats the UE should monitor.

Specifically, the UE is not expected to monitor both the compact DCI and the normal DCI in the same monitoring occasion for certain SCSs to meet the budget for the number of blind decoding. The normal DCI may comprise, for example and without limitation, DCI format 0_1 and DCI format 1_1. The UE may be configured to determine whether the compact DCI is supported on a first SCS. In an event that the compact DCI is supported on the first SCS, the UE may be configured to monitor the compact DCI on the first SCS. The UE may monitor both the compact DIC and the normal DCI on the first SCS. Thus, the UE may be configured to use the compact DCI in a control channel (e.g., PDCCH) in performing a high-reliability service (e.g., URLLC). In addition, the UE may be configured to determine whether the compact DCI is supported on a second SCS. The first SCS may be smaller than the second SCS. In an event that the compact DCI is not supported on the second SCS, the UE may be configured to cancel the monitoring of both of the compact DCI and the normal DCI on the second SCS. The UE may be configured not to monitor the compact DCI and only monitor the normal DCI on the second SCS to reduce the number of blind decoding.

For example, in scenario 301, the compact DCI may only be supported for 15 kHz SCS. The UE may be configured to monitor both the compact DCI and the normal DCI only for 15 kHz SCS. The UE may not monitor the compact DCI and may only monitor the normal DCI for 30 kHz, 60 kHz and 120 kHz SCS. In scenario 302, the UE may be configured to monitor both the compact DCI and the normal DCI only for 15 kHz and 30 kHz SCS. In scenario 303, the UE may be configured to monitor both the compact DCI and the normal DCI only for 15 kHz, 30 kHz and 60 kHz SCS.

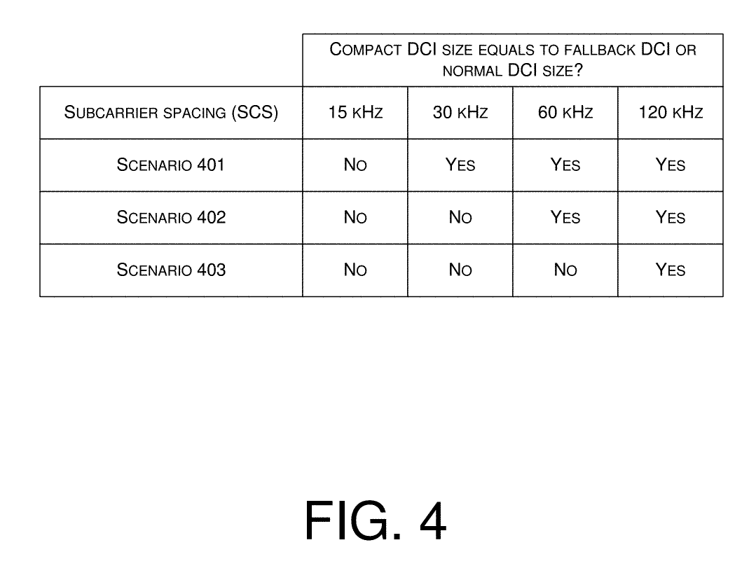

FIG. 4 illustrates example scenarios 401, 402 and 403 under schemes in accordance with implementations of the present disclosure. Scenarios 401, 402 and 403 involve a UE and a network apparatus, which may be a part of a wireless communication network (e.g., an LTE network, an LTE-Advanced network, an LTE-Advanced Pro network, a 5G network, an NR network, an loT network or an NB-IoT network). The size of the compact DCI may depend on the SCS. The UE may be configured to determine the compact DCI size according to the SCS (e.g., the first SCS or the second SCS). For example, in scenario 401, the compact DCI size may be different from the other DCI formats for 15 kHz SCS. The other DCI formats may comprise, for example and without limitation, the fallback DCI (e.g., DCI format 0_0 or DCI format 1_0) and the normal DCI (e.g., DCI format 0_1 or DCI format 1_1). For SCS>15 kHz, the compact DCI may be the same as the fallback DCI size or the normal DCI size. Some explicit or implicit methods may be used to identify between the DCI formats with the same size. In scenario 402, the compact DCI size may be different from the other DCI formats for 15 kHz and 30 kHz SCS. The compact DCI may be the same as the fallback DCI size or the normal DCI size for 60 kHz and 120 kHz SCS. In scenario 403, the compact DCI size may be different from the other DCI formats for 15 kHz, 30 kHz and 60 kHz SCS. The compact DCI may be the same as the fallback DCI size or the normal DCI size for 120 kHz SCS.

In some implementations, increase in DCI size may affect the reliability of the control channel. Different DCI sizes may increase DCI formats and hence the number of blind decoding. Accordingly, in accordance with implementations of the present disclosure, the compact DCI may be configured to have a fixed size irrespective of the active bandwidth part (BWP). The fixed compact DCI size may require the frequency domain resource allocation (FD-RA) field to have fixed number of bits irrespective of the BWP size. Thus, a fixed interpretation of FD-RA may be configured and applied to all BWPs. For example, ‘N’ may denote the number of bits required for FD-RA. N may be defined to be fixed in the 3^{rd} Generation Partnership Project (3GPP) specifications or configured by higher layer configurations (e.g., radio resource control (RRC) configurations). ‘B’ may denote the BWP in terms of resource blocks (RBs). The granularity of FD-RA may be defined as a function of (N, B) such that Granularity=ƒ(N, B). The UE may be configured to determine the RB granularity according to the function based on the choice of the BWP (e.g., B) and the number of bits required for FD-RA (e.g., N). For smaller BWP, the RB granularity for allocation may be determined as single RB. For larger BWP, the RB granularity for allocation may be determined in multiple RBs. Accordingly, the compact DCI design and operations based on the numerology may be able to reduce the number of blind decodes at the UE. The compact DCI size to be fixed irrespective of BWP may be able to reduce the DCI size and improve the reliability.

In some implementations, a number of bit fields may be reduced for the compact DCI. The size of some of the DCI fields may be SCS dependent. Such DCI field may comprise, for example and without limitation, a redundancy version (RV) index field, a maximum number of hybrid automatic repeat request (HARQ) processes, a downlink assignment index, a physical uplink control channel (PUCCH) resource, or a physical downlink shared channel (PDSCH)-to-HARQ timing indicator. The size of bit fields of some or all entries of the compact DCI may be fixed. For example, the bit fields may be defined in the 3GPP specifications. Alternatively, the bit fields of the compact DCI may also be configured through higher layer signalling (e.g., RRC signalling) or through layer 1 (L1) signalling.

In some implementations, the RV index field of DCI on the smaller SCS (e.g., the first SCS) may comprise less bits than the larger SCS (e.g., the second SCS). Specifically, for larger SCS, there are more opportunities for transmissions, and hence the target BLER for each transmission may be relaxed and the higher code rates may be used. In such scenario, gains may be achieved by using incremental redundancy (IR) combining, hence different RV version for each transmission/retransmission may be needed. Therefore, more bits may be allocated to the RV index field in the DCI. For smaller SCS, there are lesser opportunities for transmission, and the target BLER may be very small and hence lower code rates may be chosen. In such scenario, no gains or margin can be expected from IR combining. Therefore, there may not be a need for more RV versions. Less bits may be allocated to the RV index field in the DCI.

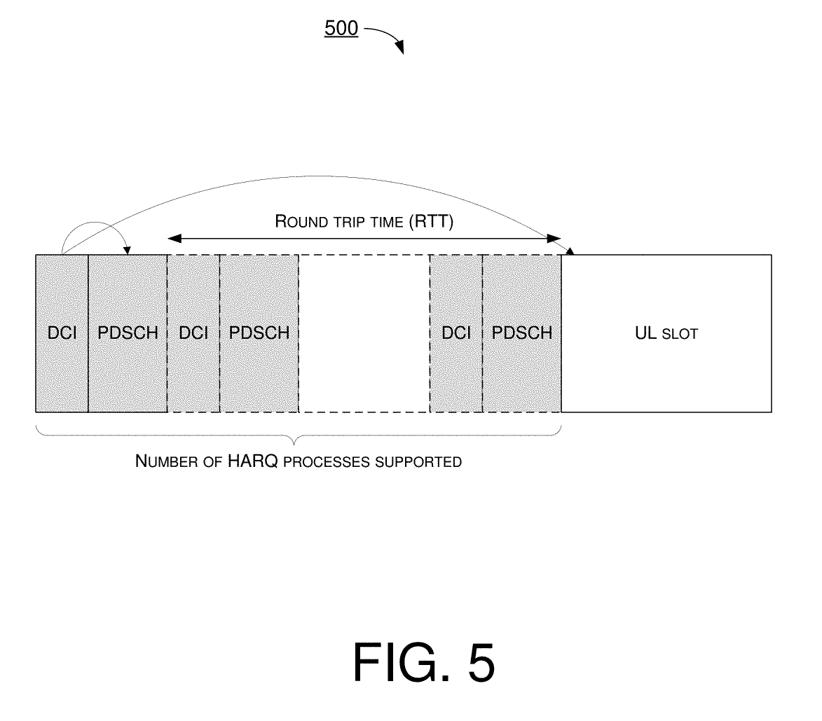

In some implementations, the maximum number of HARQ processes on the smaller SCS (e.g., the first SCS) may be less than the larger SCS (e.g., the second SCS). Specifically, the total/maximum number of HARQ process may depend on how many parallel HARQ processes can be supported within round trip time (RTT) of a transmission. The RTT may defined as the time between the downlink (DL) PDSCH transmission and the HARQ feedback. The RTT may depend on at least the UE processing time (e.g., N1) for the PDSCH decoding, which is a function of the SCS. FIG. 5 illustrates an example scenario 500 under schemes in accordance with implementations of the present disclosure. For larger RTT, more HARQ processes may be supported. Thus, more bits may be allocated to represent the number of HARQ processes. For shorter RTT, few HARQ processes may be supported. Thus, less bits may be allocated to represent the number of HARQ processes. Accordingly, the total/maximum number of HARQ processes may be smaller for the smaller SCS compared to the larger SCS.

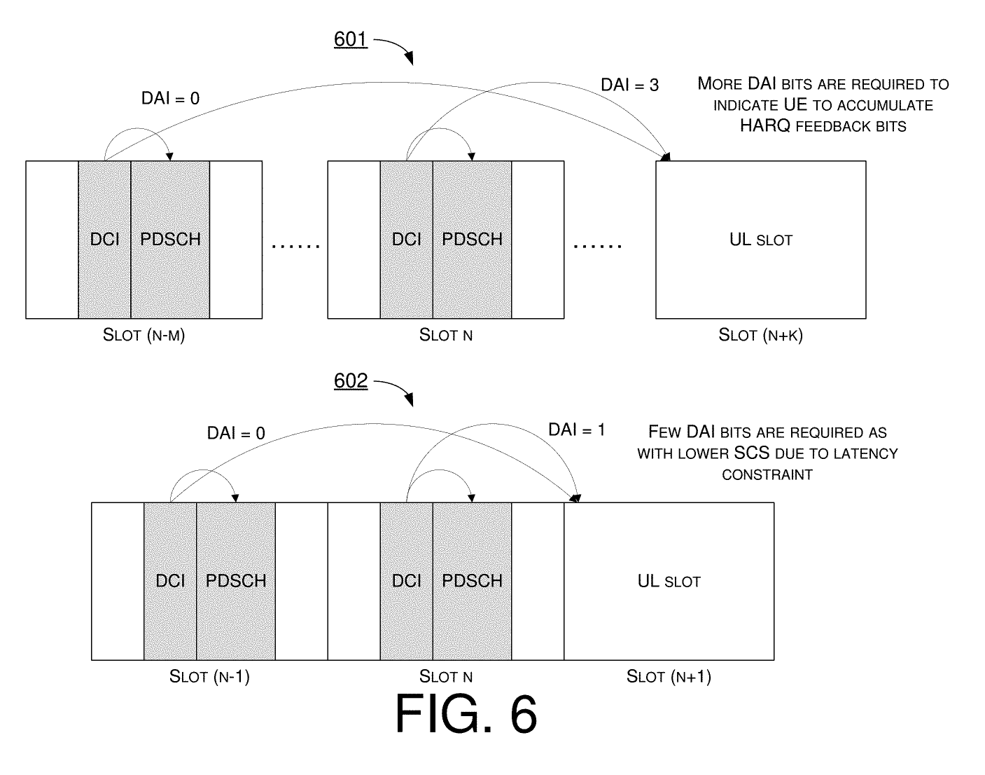

In some implementations, the downlink assignment index (DAI) on the smaller SCS (e.g., the first SCS) may comprise less bits than the larger SCS (e.g., the second SCS). Specifically, the downlink assignment index may be used to accumulate the HARQ feedback bits of previous transmissions and transmitted through a code book in single uplink (UL) PUCCH transmission. FIG. 6 illustrates an example scenarios 601 and 602 under schemes in accordance with implementations of the present disclosure. For larger SCS, as shown in scenario 601, the network apparatus may have more opportunities for transmissions. The network apparatus may configure the UE to accumulate the HARQ feedback bits for transmissions in single/few PUCCH resources. Thus, more bits in the downlink assignment index may be needed for large SCS to give more flexibility for the network apparatus in handling the HARQ feedback bits. For smaller SCS, as shown in scenario 602, the network apparatus may not configure the UE to accumulate the HARQ feedback bits over previous transmissions due to latency constraint, and hence very few bits may be required to represent the downlink assignment index.

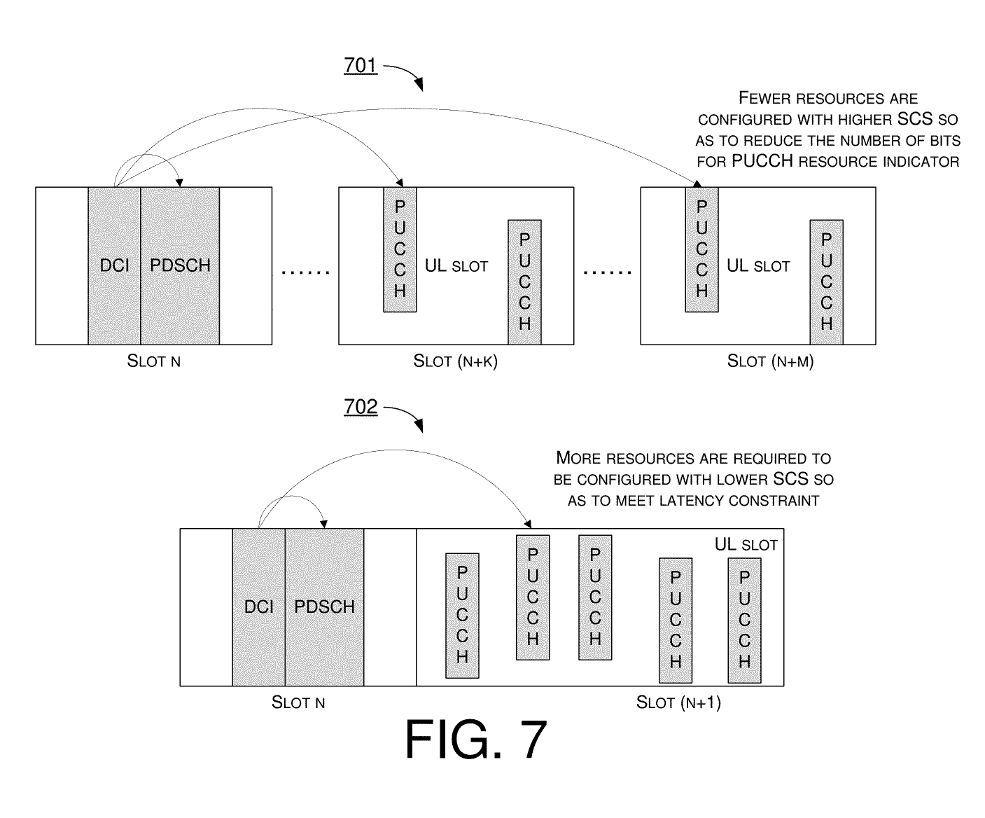

In some implementations, the PUCCH resources configured on the larger SCS (e.g., the second SCS) is less than the smaller SCS (e.g., the first SCS). Specifically, as the number of transmission opportunities increases with the SCS, the network apparatus may more flexibility in allocating PUCCH resources for larger SCS. FIG. 7 illustrates an example scenarios 701 and 702 under schemes in accordance with implementations of the present disclosure. For larger SCS, as shown in scenario 701, lesser PUCCH resources per UL slot is required as the network apparatus may have flexibility in allocating resources in future UL slots and still can satisfy latency constraint. The network apparatus may have more UL opportunities to allocate the PUCCH resources hence PUCCH resource indicator field may be shortened. Thus, fewer resources may be configured with higher SCS so as to reduce the number of bits for the PUCCH resource indicator. For smaller SCS, as shown in scenario 702, more PUCCH resources may be required in an UL slot as feedback opportunities may be lesser due to latency constraint. The network apparatus may have lesser UL opportunities to allocate the PUCCH resources hence more PUCCH resources may be configured. Thus, more resources may be required to be configured with lower SCS so as to meet the latency constraint.

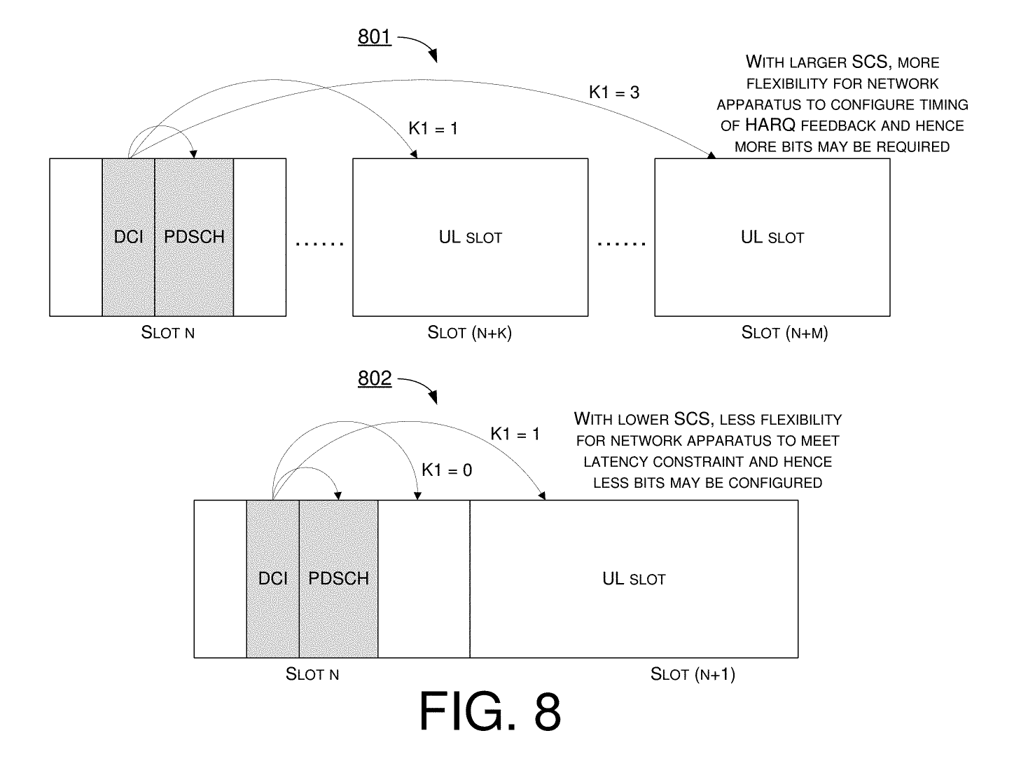

In some implementations, the HARQ timing indicator configured on the smaller SCS (e.g., the first SCS) may comprise less bits than the larger SCS (e.g., the second SCS). Specifically, the PDSCH-to-HARQ feedback timing indicator may be used to indicate the UE the slot for transmitting the HARQ feedback corresponding to the received PDSCH. FIG. 8 illustrates an example scenarios 801 and 802 under schemes in accordance with implementations of the present disclosure. For larger SCS, as shown in scenario 801, there are more opportunities in UL slots for HARQ feedback transmission and hence HARQ timing indicator may have more entries (e.g., more bits required to represent). The network apparatus may have more flexibility for indicating the HARQ feedback timing. Thus, more bits may be configured for the HARQ feedback timing indicator. For smaller SCS, as shown in scenario 802, since there are lesser opportunities for the HARQ retransmissions and given the latency requirements for URLLC, it is expected that the HARQ timing indicator may be pointed to the earliest slot. For example, the slot number indication (e.g., K1) may point to 0 or 1 in small SCS which only require 1 bit for this field. Thus, less bits may be configured for the HARQ feedback timing indicator. Illustrative Implementations

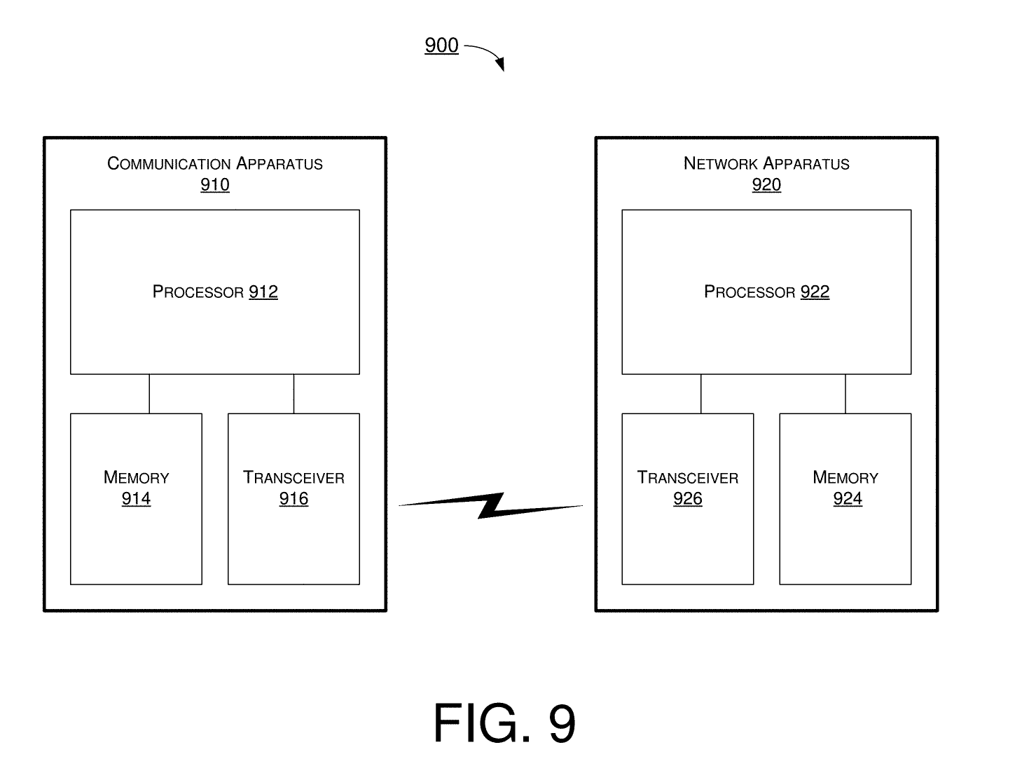

FIG. 9 illustrates an example communication apparatus 910 and an example network apparatus 920 in accordance with an implementation of the present disclosure. Each of communication apparatus 910 and network apparatus 920 may perform various functions to implement schemes, techniques, processes and methods described herein pertaining to compact DCI design and operations with respect to user equipment and network apparatus in wireless communications, including scenarios described above as well as process 1000 described below.

Communication apparatus 910 may be a part of an electronic apparatus, which may be a UE such as a portable or mobile apparatus, a wearable apparatus, a wireless communication apparatus or a computing apparatus. For instance, communication apparatus 910 may be implemented in a smartphone, a smartwatch, a personal digital assistant, a digital camera, or a computing equipment such as a tablet computer, a laptop computer or a notebook computer. Communication apparatus 910 may also be a part of a machine type apparatus, which may be an loT or NB-IoT apparatus such as an immobile or a stationary apparatus, a home apparatus, a wire communication apparatus or a computing apparatus. For instance, communication apparatus 910 may be implemented in a smart thermostat, a smart fridge, a smart door lock, a wireless speaker or a home control center. Alternatively, communication apparatus 910 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 910 may include at least some of those components shown in FIG. 5 such as a processor 912, for example. Communication apparatus 910 may further include one or more other components not pertinent to the proposed scheme of the present disclosure (e.g., internal power supply, display device and/or user interface device), and, thus, such component(s) of communication apparatus 910 are neither shown in FIG. 9 nor described below in the interest of simplicity and brevity.

Network apparatus 920 may be a part of an electronic apparatus, which may be a network node such as a base station, a small cell, a router or a gateway. For instance, network apparatus 920 may be implemented in an eNodeB in an LTE, LTE-Advanced or LTE-Advanced Pro network or in a gNB in a 5G, NR, loT or NB-IoT network. Alternatively, network apparatus 920 may be implemented in the form of one or more IC chips such as, for example and without limitation, one or more single-core processors, one or more multi-core processors, or one or more RISC or CISC processors. Network apparatus 920 may include at least some of those components shown in FIG. 9 such as a processor 922, for example. Network apparatus 920 may further include one or more other components not pertinent to the proposed scheme of the present disclosure (e.g., internal power supply, display device and/or user interface device), and, thus, such component(s) of network apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more RISC or CISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including power consumption reduction in a device (e.g., as represented by communication apparatus 910) and a network (e.g., as represented by network apparatus 920) in accordance with various implementations of the present disclosure.

In some implementations, communication apparatus 910 may also include a transceiver 916 coupled to processor 912 and capable of wirelessly transmitting and receiving data. In some implementations, communication apparatus 910 may further include a memory 914 coupled to processor 912 and capable of being accessed by processor 912 and storing data therein. In some implementations, network apparatus 920 may also include a transceiver 926 coupled to processor 922 and capable of wirelessly transmitting and receiving data. In some implementations, network apparatus 920 may further include a memory 924 coupled to processor 922 and capable of being accessed by processor 922 and storing data therein. Accordingly, communication apparatus 910 and network apparatus 920 may wirelessly communicate with each other via transceiver 916 and transceiver 926, respectively. To aid better understanding, the following description of the operations, functionalities and capabilities of each of communication apparatus 910 and network apparatus 920 is provided in the context of a mobile communication environment in which communication apparatus 910 is implemented in or as a communication apparatus or a UE and network apparatus 920 is implemented in or as a network node of a communication network.

In some implementations, compact DCI design and/or operations may be configured to be SCS depended. Communication apparatus 910 and/or network apparatus 920 may be configured to support the compact DCI for some specific SCSs. For example, communication apparatus 910 and/or network apparatus 920 may be configured to support the compact DCI only for 15 kHz SCS, and communication apparatus 910 and/or network apparatus 920 may be configured not to support the compact DCI for other SCSs (e.g., 30 kHz, 60 kHz and 120 kHz).

In some implementations, the monitoring of the compact DCI may be restricted on specific SCSs. When processor 912 is configured to monitor the compact DCI, some limits may be configured on the other DCI formats processor 912 should monitor. Specifically, processor 912 is not expected to monitor both the compact DCI and the normal DCI in the same monitoring occasion for certain SCSs to meet the budget for the number of blind decoding. The normal DCI may comprise, for example and without limitation, DCI format 0_1 and DCI format 1_1. Processor 912 may be configured to determine whether the compact DCI is supported on a first SCS. In an event that the compact DCI is supported on the first SCS, processor 912 may be configured to monitor, via transceiver 916, the compact DCI on the first SCS. Processor 912 may monitor both the compact DIC and the normal DCI on the first SCS. Thus, processor 912 may be configured to perform a high-reliability service (e.g., URLLC) using the compact DCI in a control channel (e.g., PDCCH). In addition, processor 912 may be configured to determine whether the compact DCI is supported on a second SCS. The first SCS may be smaller than the second SCS. In an event that the compact DCI is not supported on the second SCS, processor 912 may be configured to cancel the monitoring of both of the compact DCI and the normal DCI on the second SCS. Processor 912 may be configured not to monitor the compact DCI and only monitor the normal DCI on the second SCS to reduce the number of blind decoding. For example, the compact DCI may only be supported for 15 kHz SCS. Processor 912 may be configured to monitor, via transceiver 916, both the compact DCI and the normal DCI only for 15 kHz SCS. Processor 912 may not monitor the compact DCI and may only monitor the normal DCI for 30 kHz, 60 kHz and 120 kHz SCS.

In some implementations, the size of the compact DCI may depend on the SCS. Processor 912 may be configured to determine the compact DCI size according to the SCS (e.g., the first SCS or the second SCS). For example, the compact DCI size may be different from the other DCI formats for 15 kHz SCS. The other DCI formats may comprise, for example and without limitation, the fallback DCI (e.g., DCI format 0_0 or DCI format 1_0) and the normal DCI (e.g., DCI format 0_1 or DCI format 1_1). For SCS>15 kHz, the compact DCI may be the same as the fallback DCI size or the normal DCI size. Some explicit or implicit methods may be used by processor 912 to identify between the DCI formats with the same size.

In some implementations, processor 922 may be configured to use a fixed size for the compact DCI irrespective of the BWP. The fixed compact DCI size may require the FD-RA field to have fixed number of bits irrespective of the BWP size. Thus, processor 922 may configure a fixed interpretation of FD-RA and apply to all BWPs. Processor 912 may be configured to determine the RB granularity according to the function based on the choice of the BWP (e.g., B) and the number of bits required for FD-RA (e.g., N). For smaller BWP, processor 912 may determine the RB granularity as single RB. For larger BWP, processor 912 may determine the RB granularity for allocation in multiple RBs. Accordingly, the compact DCI design and operations based on the numerology may be able to reduce the number of blind decodes at communication apparatus 910. The compact DCI size to be fixed irrespective of BWP may be able to reduce the DCI size and improve the reliability.

In some implementations, a number of bit fields may be reduced for the compact DCI. The size of some of the DCI fields may be SCS dependent. The size of bit fields of some or all entries of the compact DCI may be fixed. For example, the bit fields may be defined in the 3GPP specifications. Alternatively, network apparatus 920 may configure the bit fields of the compact DCI through higher layer signalling (e.g., RRC signalling) or through L1 signalling.

In some implementations, processor 922 may configure the RV index field of DCI on the smaller SCS (e.g., the first SCS) with less bits than the larger SCS (e.g., the second SCS). For larger SCS, there are more opportunities for transmissions, and hence the target BLER for each transmission may be relaxed and the higher code rates may be used. In such scenario, gains may be achieved by using IR combining, hence different RV version for each transmission/retransmission may be needed. Therefore, processor 922 may allocate more bits to the RV index field in the DCI. For smaller SCS, there are lesser opportunities for transmission, and the target BLER may be very small and hence lower code rates may be chosen. In such scenario, no gains or margin can be expected from IR combining. Therefore, processor 922 may allocate less bits to the RV index field in the DCI.

In some implementations, processor 922 may configure the maximum number of HARQ processes on the smaller SCS (e.g., the first SCS) to be less than the larger SCS (e.g., the second SCS). For larger RTT, more HARQ processes may be supported. Thus, processor 922 may allocate more bits to represent the number of HARQ processes. For shorter RTT, few HARQ processes may be supported. Thus, processor 922 may allocate less bits to represent the number of HARQ processes.

In some implementations, processor 922 may configure the DAI on the smaller SCS (e.g., the first SCS) to comprise less bits than the larger SCS (e.g., the second SCS). For larger SCS, processor 922 may have more opportunities for transmissions. Processor 922 may configure communication apparatus 910 to accumulate the HARQ feedback bits for transmissions in single/few PUCCH resources. Thus, processor 922 may need more bits in the downlink assignment index for large SCS to give more flexibility in handling the HARQ feedback bits. For smaller SCS, processor 922 may not configure communication apparatus 910 to accumulate the HARQ feedback bits over previous transmissions due to latency constraint. Thus, processor 922 may use very few bits to represent the downlink assignment index.

In some implementations, processor 922 may configure less PUCCH resources on the larger SCS (e.g., the second SCS) than the smaller SCS (e.g., the first SCS). For larger SCS, processor 922 may require lesser PUCCH resources per UL slot as processor 922 may have flexibility in allocating resources in future UL slots and still can satisfy latency constraint. Processor 922 may have more UL opportunities to allocate the PUCCH resources hence PUCCH resource indicator field may be shortened. Thus, processor 922 may configure fewer resources with higher SCS so as to reduce the number of bits for the PUCCH resource indicator. For smaller SCS, processor 922 may require more PUCCH resources in an UL slot as feedback opportunities may be lesser due to latency constraint. Processor 922 may have lesser UL opportunities to allocate the PUCCH resources hence more PUCCH resources may be configured. Thus, processor 922 may configure more resources with lower SCS so as to meet the latency constraint.

In some implementations, processor 922 may configure the HARQ timing indicator on the smaller SCS (e.g., the first SCS) to comprise less bits than the larger SCS (e.g., the second SCS). For larger SCS, processor 912 may have more opportunities in UL slots for HARQ feedback transmission and hence HARQ timing indicator may have more entries (e.g., more bits required to represent). Processor 922 may have more flexibility for indicating the HARQ feedback timing. Thus, processor 922 may configure more bits for the HARQ feedback timing indicator. For smaller SCS, since processor 912 may have lesser opportunities for the HARQ retransmissions and given the latency requirements for URLLC, it is expected that the HARQ timing indicator may be pointed to the earliest slot. For example, the slot number indication (e.g., K1) may point to 0 or 1 in small SCS which only require 1 bit for this field. Thus, processor 922 may configure less bits for the HARQ feedback timing indicator.

### Illustrative Processes

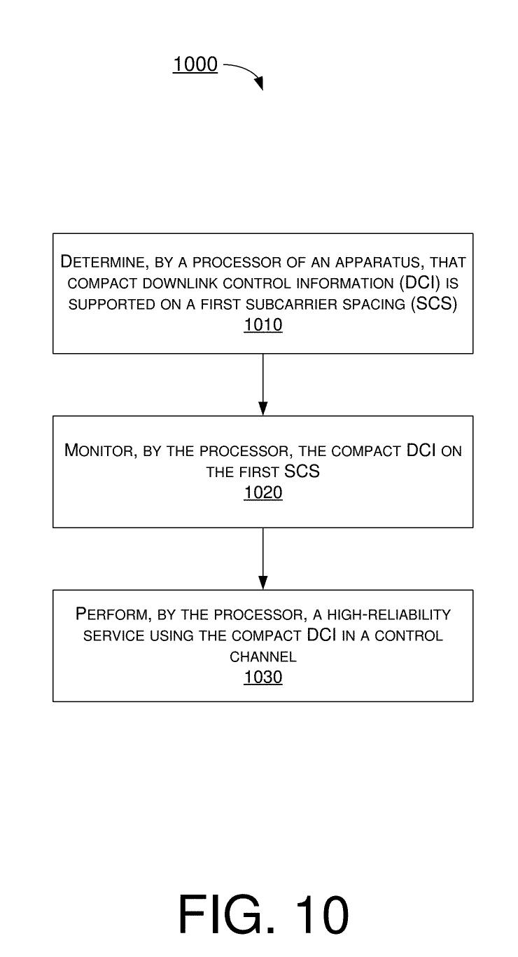

FIG. 10 illustrates an example process 1000 in accordance with an implementation of the present disclosure. Process 1000 may be an example implementation of scenarios described above, whether partially or completely, with respect to compact DCI design and operations with the present disclosure. Process 1000 may represent an aspect of implementation of features of communication apparatus 910. Process 1000 may include one or more operations, actions, or functions as illustrated by one or more of blocks 1010, 1020 and 1030. Although illustrated as discrete blocks, various blocks of process 1000 may be divided into additional blocks, combined into fewer blocks, or eliminated, depending on the desired implementation. Moreover, the blocks of process 1000 may executed in the order shown in FIG. 10 or, alternatively, in a different order. Process 1000 may be implemented by communication apparatus 910 or any suitable UE or machine type devices. Solely for illustrative purposes and without limitation, process 1000 is described below in the context of communication apparatus 910. Process 1000 may begin at block 1010.

At 1010, process 1000 may involve processor 912 of apparatus 910 determining that compact DCI is supported on a first SCS. Process 1000 may proceed from 1010 to 1020.

At 1020, process 1000 may involve processor 912 monitoring the compact DCI on the first SCS. Process 1000 may proceed from 1020 to 1030.

At 1030, process 1000 may involve processor 912 performing a high-reliability service using the compact DCI in a control channel.

In some implementations, process 1000 may involve processor 912 monitoring both the compact DCI and normal DCI on the first SCS.

In some implementations, process 1000 may involve processor 912 determining that the compact DCI is not supported on a second SCS. Process 1000 may also involve processor 912 cancelling the monitoring of both of the compact DCI and the normal DCI on the second SCS. The first SCS may be smaller than the second SCS.

In some implementations, the size of the compact DCI may be determined according to the first SCS.

In some implementations, the size of the compact DCI may be fixed irrespective of the BWP.

In some implementations, the RV index field on the first SCS may comprise less bits than the second SCS.

In some implementations, the maximum number of HARQ processes on the first SCS may be less than the second SCS.

In some implementations, the downlink assignment index on the first SCS may comprise less bits than the second SCS.

In some implementations, the PUCCH resource configured on the second SCS may be less than the first SCS.

In some implementations, the HARQ feedback timing indicator on the first SCS may comprise less bits than the second SCS.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, that compact downlink control information (DCI) is supported on a first subcarrier spacing (SCS);
monitoring, by the processor, the compact DCI on the first SCS; and
performing, by the processor, a high-reliability service using the compact DCI in a control channel.

2. The method of claim 1, further comprising:
monitoring, by the processor, both the compact DCI and normal DCI on the first SCS.

3. The method of claim 2, further comprising:
determining, by the processor, that the compact DCI is not supported on a second SCS; and
cancelling, by the processor, the monitoring of both of the compact DCI and the normal DCI on the second SCS,
wherein the first SCS is smaller than the second SCS.

4. The method of claim 1, wherein size of the compact DCI is determined according to the first SCS.

5. The method of claim 1, wherein size of the compact DCI is fixed irrespective of active bandwidth part (BWP).

6. The method of claim 3, wherein a redundancy version (RV) index field on the first SCS comprises less bits than the second SCS.

7. The method of claim 3, wherein a maximum number of hybrid automatic repeat request (HARQ) processes on the first SCS is less than the second SCS.

8. The method of claim 3, wherein a downlink assignment index on the first SCS comprises less bits than the second SCS.

9. The method of claim 3, wherein a physical uplink control channel (PUCCH) resource configured on the second SCS is less than the first SCS.

10. The method of claim 3, wherein a hybrid automatic repeat request (HARQ) feedback timing indicator on the first SCS comprises less bits than the second SCS.

11. An apparatus, comprising:
a transceiver capable of wirelessly communicating with a network node of a wireless network; and
a processor communicatively coupled to the transceiver, the processor capable of:
determining that compact downlink control information (DCI) is supported on a first subcarrier spacing (SCS);
monitoring, via the transceiver, the compact DCI on the first SCS; and
performing a high-reliability service using the compact DCI in a control channel.

12. The apparatus of claim 11, wherein the processor is further capable of:
monitoring, via the transceiver, both the compact DCI and normal DCI on the first SCS.

13. The apparatus of claim 12, wherein the processor is further capable of:
determining that the compact DCI is not supported on a second SCS; and
cancelling, by the processor, the monitoring of both of the compact DCI and the normal DCI on the second SCS,
wherein the first SCS is smaller than the second SCS.

14. The apparatus of claim 11, wherein size of the compact DCI is determined according to the first SCS.

15. The apparatus of claim 11, wherein size of the compact DCI is fixed irrespective of active bandwidth part (BWP).

16. The apparatus of claim 13, wherein a redundancy version (RV) index field on the first SCS comprises less bits than the second SCS.

17. The apparatus of claim 13, wherein a maximum number of hybrid automatic repeat request (HARQ) processes on the first SCS is less than the second SCS.

18. The apparatus of claim 13, wherein a downlink assignment index on the first SCS comprises less bits than the second SCS.

19. The apparatus of claim 13, wherein a physical uplink control channel (PUCCH) resource configured on the second SCS is less than the first SCS.

20. The apparatus of claim 13, wherein a hybrid automatic repeat request (HARQ) feedback timing indicator on the first SCS comprises less bits than the second SCS.
